(19) United States
(12) Patent Application Publication
(10) Pub. No.: US 2026/0005529 A1
(43) Pub. Date: Jan. 1, 2026

(54) METHODS AND DEVICES FOR IMPROVING MEASURED COUPLED ELECTROMAGNETIC PROPERTIES BETWEEN MOBILE DEVICES AND THEIR MOUNTS

(71) Applicant: Peak Design, San Francisco, CA (US)

(72) Inventors: Samuel Girvin, San Francisco, CA (US); Andrew Wheeler Gans, San Francisco, CA (US)

(21) Appl. No.: 19/248,596

(22) Filed: Jun. 25, 2025

Related U.S. Application Data
(60) Provisional application No. 63/664,301, filed on Jun. 26, 2024.

(51) Int. Cl. H02J 7/00; H02J 50/10

(52) U.S. Cl. CPC H02J 7/0044; H02J 50/10

(57) ABSTRACT

Methods and devices for improving measured coupled electromagnetic properties between a mobile device and a charging mobile device mount are provided.

This patent application claims the benefit of priority from U.S. Provisional Application Ser. No. 63/664,301 filed Jun. 26, 2024, teachings of which are hereby incorporated by reference in their entirety.

### BACKGROUND

Electromagnetic induction is a process that generates a magnetic field to charge batteries. The process abides by a similar principle to that of the transformer, with primary coils or charging pads located in the transmitters and secondary coils placed within receivers or mobile devices.

Qi (pronounced “chee”) is an open, collaborative wireless charging industry standard developed by the Wireless Power Consortium (WPC) and has become one of the most widely adopted industry standards within the consumer electronics market. Qi currently supports up to 15 W of power transfer to mobile phones and handheld devices.

WPC introduced Version 1.0 of the Qi wireless charging standard in 2010, which supported single coil, coil arrays, and moving coil designs that allowed transmitters to deliver up to 5 W of power. However, Version 1.0 transmitters had limited flexibility. Thus, manufacturers could only optimize the wireless charging process by making adjustments to Qi receiver designs.

In 2012, version 1.1 increased the number of supported transmitter types to 12, giving manufacturers greater flexibility and design freedom. Furthermore, Qi 1.1 wireless chargers also featured improved sensitivity for foreign object detection, an attribute that plays a significant role in user safety and usability. In addition, Qi 1.1 transmitters could also be powered by USB chargers.

The Qi standard experienced a major breakthrough in 2015 with Version 1.2. This release came alongside the advent of the Extended Power Profile (EPP) that increased charging speeds to 15 W. Power receivers received unique IDs, and thermal tests were also introduced to further optimize transmitter performance under various temperature conditions.

In 2021 WPC introduced Qi Version 1.3. This version had a multitude of updates, including more authentication, as well as increased safety, consistency and reliability.

In 2023, the Qi2 wireless charging standard was announced with Magnetic Power Profile (MPP) along with few updates to legacy BPP and EPP power profiles. Designed to provide consumers with greater levels of convenience, efficiency, and safety, legacy MPP profiles are expected to co-exist with newer Qi standards for the foreseeable future.

Building on the success of the Qi standard, the Qi v2.0 standard is expected to unify the world under one global wireless charging standard for handheld and mobile devices. Foremost among the coming Qi v2.0 products is Qi2 with a faster, more efficient charging experience. Qi2 uses a magnetic power profile which creates a perfect alignment between receivers and transmitters. This means more efficient charging with less energy loss; and less energy loss means faster charging. When a Qi2 Certified phone is charged with a Qi2 Certified charger, it receives up to 15 W of power for faster charging. The magnetic attachment also eliminates the need to find that “charging sweet spot” between phone and charger.

It is expected that these industry standards for wireless charging will continue to improve and there is a need for methods and devices for improving measured coupled electromagnetic properties between mobile devices and their mounts to comply with these industry standards.

### SUMMARY OF THE INVENTION

An aspect of this disclosure relates to methods for improving one or more measured coupled electromagnetic properties between a mobile device and a charging mobile device mount. In these methods, a charging mobile device mount is produced with a mounting head with a charging element and securing means for a mobile device which achieves a flat profile adjacent with a mobile device when mounted. Various means for achieving this flat profile can be used including, but not limited to, providing a removable, installable or retractable transiently protruding securing means for the mounting head and/or a securing means reliant upon magnetic attraction.

Another aspect of this disclosure relates to charging mobile device mounts with improved measured coupled electromagnetic properties between a mobile device and the charging mobile device mount. Mounts of this disclosure comprise a base head with a planar top surface, a charging coil, also referred to as an induction coil, integrated into the base head, and a securing means for a mobile device which achieves a flat profile adjacent with the base head and a mobile device when mounted thereto. Various means for achieving this flat profile can be used including, but not limited to, providing a removable, installable or retractable transiently protruding securing means for the mounting head and/or a securing means reliant upon magnetic attraction.

### BRIEF DESCRIPTION OF THE FIGURES

FIGS. 1A and 1B diagrams of a nonlimiting embodiment of a mounting head of this disclosure with a base head with a planar top surface.

FIG. 2 provides a closer view of a nonlimiting embodiment of a base head with a planar top surface.

FIG. 3 provides a diagram of individual components of a nonlimiting embodiment of a charging head used in the charging mobile device mounts of this disclosure.

FIG. 4 provides a diagram of individual components of a nonlimiting embodiment of a charging head used in the charging mobile device mounts of this disclosure with an installable boss as the securing means.

### DETAILED DESCRIPTION OF THE INVENTION

Disclosed herein are methods and devices for improving measured coupled electromagnetic properties between mobile devices and their charging mounts. In the methods and devices of this disclosure, measured coupled electromagnetic properties are improved via mounting heads having a flat profile adjacent with a mobile device when mounted.

By “measured coupled electromagnetic properties”, as used herein, it is meant to include, but is not limited to, magnetic coupling, resistive coupling, coupled inductance on a transmitter or receiver, and/or coupled resistance on a transmitter or receiver.

By “improving”, “improve”, “improved”, or improvement” as used herein, it is meant to enhance, expand or increase one or more of these electromagnetic properties as compared to a charging mount without a flat profile adjacent with a mobile device when mounted.

In one nonlimiting embodiment, these improvements result in compliance with one or more industry standards for wireless charging.

In one nonlimiting embodiment, these improvements result in compliance with Qi2 industry standards.

Methods of this disclosure comprise producing a charging mobile device mount comprising a mounting head with a charging element and one or more securing means for a mobile device which are capable of achieving a flat profile adjacent with a mobile device when mounted.

Any securing means for achieving a flat profile resulting in improvement of one or more measured coupled electromagnetic properties between a mobile device and the charging mobile device mount can be used.

In one nonlimiting embodiment, one or more of the securing means is transiently protruding.

In one nonlimiting embodiment, one or more transiently protruding securing means of the mounting head is removable. A nonlimiting example of a removable securing means is a removable boss.

In another nonlimiting embodiment, one or more transiently protruding securing means of the mounting head is installable. A nonlimiting example of an installable securing means is an installable boss such as depicted in FIG. 4.

In another nonlimiting embodiment, one or more transiently protruding securing means of the mounting head is retractable.

In one nonlimiting embodiment, the transiently protruding securing means extends out from and retracts into the center of the charging element. In one nonlimiting embodiment, the transiently protruding securing means retracts into the center of the charging element through the region encircled by the charging coil. Accordingly, in these nonlimiting embodiments with a transiently protruding securing means, the charging mobile device mount can be in different modes or states, at least one being wherein the securing means is flush with the planar top surface and then others modes or states wherein the securing means extends beyond the planar surface.

In another nonlimiting embodiment, the securing means relies on magnetic attraction. In this nonlimiting embodiment, the securing means may rely only upon magnetic attraction or may further comprise magnetic attraction as an additional securing means.

In some nonlimiting embodiments with a magnetic securing means, a mobile device placed near the charging mobile device mount autolocks into a selected orientation via the magnetic interaction.

In one nonlimiting embodiment, the securing means further comprises a retractable claw or claws. In one nonlimiting embodiment, the retractable claw or claws extends through the central region of the charging element and retracts into the center of the charging element. In one nonlimiting embodiment, the claw or claws retracts into the center of the charging element through the region encircled by the charging coil.

In some nonlimiting embodiments, the securing means further comprises an ejection means for release of a mobile device mounted to the charging mobile device mount. Nonlimiting examples of ejection means include a button or lever, which when pressed, facilitates release of the handheld electronic device from the head of the mount.

Any of the above-described securing means can be used alone or in various combinations in the mounting heads of this disclosure and all uses alone or in the various combinations are considered within the scope of this disclosure.

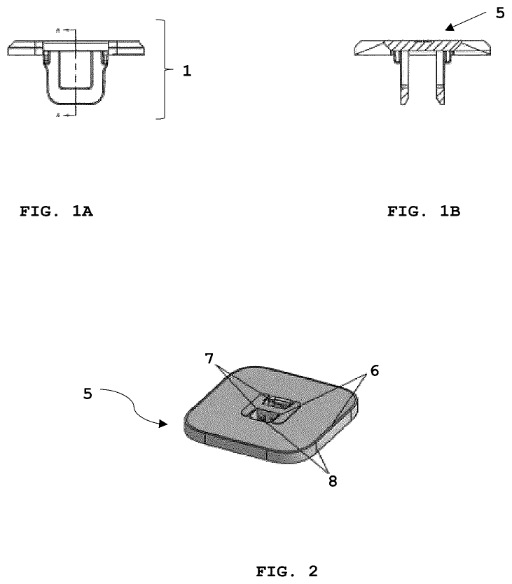

Charging mobile device mounts of this disclosure comprise a base head 5 with a planar top surface 6, a charging coil 10, also referred to an induction coil, integrated into the base head 5, and a securing means 15 for a mobile device which achieves a flat profile adjacent with the base head and a mobile device when mounted thereto. Nonlimiting embodiments of charging mobile device mounts 1 of this disclosure are depicted in FIGS. 1A through 4.

The charging mobile device mount 1 may further comprise a base to which the base head 5 is attached. Various bases can be used in the mounts of this disclosure and can be selected based upon the use for the mount. Examples include, but are not limited to, wall mounts, car mounts, bike mounts, sports vehicle mounts, or desktop charging mounts.

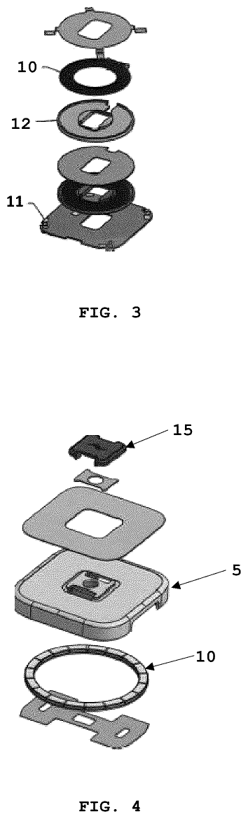

Further, in addition to the charging coil 10, as shown in FIGS. 3 and 4, in some nonlimiting embodiments, the base head 2 may further comprise a printed circuit board assembly 11 and/or a ferrite element 12. In one nonlimiting embodiment, the ferrite element 12 comprises a ring around the charging coil.

Any securing means 15 for achieving a flat profile resulting in improvement of one or more measured coupled electromagnetic properties between a mobile device and the charging mobile device mount can be used.

In one nonlimiting embodiment, one or more of the securing means is transiently protruding. In one nonlimiting embodiment, the securing means protrude through holes 7 in the base head 5.

In one nonlimiting embodiment, both the inner surface of the hole and side of the base head have polished surfaces 8.

In one nonlimiting embodiment, one or more transiently protruding securing means of the mounting head is removable. A nonlimiting example of a removable securing means is a removable boss.

In another nonlimiting embodiment, one or more transiently protruding securing means of the mounting head is installable. A nonlimiting example of an installable securing means is an installable boss.

In another nonlimiting embodiment, one or more transiently protruding securing means of the mounting head is retractable.

In one nonlimiting embodiment, the transiently protruding securing means extends out from and retracts into the center of the charging element. In one nonlimiting embodiment, the transiently protruding securing means retracts into the center of the charging element through the region encircled by the charging coil. Accordingly, in these nonlimiting embodiments with a transiently protruding securing means, the charging mobile device mount can be in different modes or states, at least one being wherein the securing means is flush with the planar top surface and then others modes or states wherein the securing means extends beyond the planar surface.

In another nonlimiting embodiment, the securing means relies on magnetic attraction. In this nonlimiting embodiment, the securing means may rely only upon magnetic attraction or may further comprise magnetic attraction as an additional securing means.

In some nonlimiting embodiments with a magnetic securing means, a mobile device placed near the charging mobile device mount autolocks into a selected orientation via the magnetic interaction.

In one nonlimiting embodiment, the securing means further comprises a retractable claw or claws. In one nonlimiting embodiment, the retractable claw or claws extends through the central region of the charging element and retracts into the center of the charging element. In one nonlimiting embodiment, the claw or claws retracts into the center of the charging element through the region encircled by the charging coil.

In some nonlimiting embodiments, the securing means further comprises an ejection means for release of a mobile device mounted to the charging mobile device mount. Nonlimiting examples of ejection means include a button or lever, which when pressed, facilitates release of the handheld electronic device from the head of the mount.

Any of the above-described securing means can be used alone or in various combinations in the mounting heads of this disclosure and all uses alone or in the various combinations are considered within the scope of this disclosure.

The charging mobile device mounts of this disclosure improve one or more of electromagnetic properties including, but not limited to, magnetic coupling, resistive coupling, coupled inductance on a transmitter or receiver, and/or coupled resistance on a transmitter or receiver. Improvements are measured by comparison to a charging mount without a flat profile adjacent with a mobile device when mounted.

In one nonlimiting embodiment, these improvements result in compliance with one or more industry standards for wireless charging.

In one nonlimiting embodiment, these improvements result in compliance with Qi2 industry standards.

1. A method for improving one or more measured coupled electromagnetic properties between a mobile device and a charging mobile device mount, said method comprising producing a charging mobile device mount comprising a mounting head with a charging element and one or more securing means for a mobile device, wherein said mounting head achieves a flat profile adjacent with a mobile device when mounted.

2. The method of claim 1, wherein one or more securing means of the mounting head is removable and/or installable.

3. The method of claim 1, wherein one or more securing means is retractable.

4. The method of claim 1, wherein one or more securing means further comprises a retractable claw or claws.

5. The method of claim 1, wherein one or more securing means extends out from and retracts into a center region of the charging element.

6. The method of claim 1, wherein one or more securing means retracts into the center of the charging element through the region encircled by the charging coil.

7. The method of claim 1, wherein one or more securing means relies on magnetic attraction.

8. The method of claim 7, wherein a mobile device placed near the charging mobile device mount autolocks into a selected orientation via magnetic interaction.

9. The method of claim 1, wherein the securing means relies only on magnetic attraction.

10. The method of claim 1, wherein one or more securing means further comprises an ejection means for release of a mobile device mounted to the charging mobile device mount.

11. A charging mobile device mount with improved measured coupled electromagnetic properties between a mobile device and the charging mobile device mount, said mount comprising:
a base head with a planar top surface;
a charging coil integrated into the base head; and
one or more securing means for a mobile device which achieves a flat profile adjacent with the base head and a mobile device when mounted thereto.

12. The charging mobile device mount of claim 11, further comprising a base.

13. The charging mobile device mount of claim 11, wherein one or more securing means comprises one or more magnets.

14. The charging mobile device mount of claim 13, wherein a mobile device placed near the charging mobile device mount autolocks into a selected orientation via magnetic interaction.

15. The charging mobile device mount of claim 11, wherein one or more securing means is a removable and/or installable securing means.

16. The charging mobile device mount of claim 11, wherein one or more securing means is a retractable securing means.

17. The charging mobile device mount of claim 11, further comprising an ejection means for release of a mobile device mounted to the charging mobile device mount.

18. The charging mobile device mount of claim 11, wherein one or more securing means further comprises a retractable claw or claws.

19. The charging mobile device mount of claim 11, wherein one or more securing means extends out from and retracts into a center region of the charging element.

20. The charging mobile device mount of claim 11, wherein one or more securing means retracts into the center of the charging element through the region encircled by the charging coil.
